(19) United States
(12) Patent Application Publication
(10) Pub. No.: US 2011/0061318 A1
(43) Pub. Date: Mar. 17, 2011

(54) FIRESHIELD DEVICE FOR HOME PROTECTION AGAINST THREATENING WILDFIRES

(76) Inventor: Henry August, Chatsworth, CA (US)

(21) Appl. No.: 12/832,236

(22) Filed: Aug. 16, 2010

Related U.S. Application Data
(60) Provisional application No. 61/276,398, filed on Sep. 11, 2009.

(51) Int. Cl. E04B 1/94; E06B 3/26

(52) U.S. Cl. 52/202

(57) ABSTRACT

The FIRESHIELD approach presented herein is unique and designed as a barrier-like device capable of preventing wildfire embers from entering a structure's attic through its air vents while preserving the mold-resistant qualities as that of an open air vent. Modifications of air vents to a rooftop's attic are to be made with the retrofitting of an oversized FIRESHIELD panel that is externally mounted with a narrow ‘standoff’ gapped region. This panel acts as a barrier to wildfire driven embers and also forms an inner air channel pathway that accommodates air ventilation to the attic. This unique design is called a FIRESHIELD device and covers the typical air vent with an external attachment device consisting of a low cost, sheet-like panel (such as an aluminum sheet) with attachment to the rooftop air vent so as to provide a narrow ‘standoff’ air gap for maintaining ventilation. In this manner, inner-attic rooftop fire starts typically caused by air vent ingested embers that initiate from urban wildfires can largely be avoided and many lives and homes could be saved due to the application of this invention.

### STATEMENT OF NO NEW MATTER

The substitute specification as well as this revised specification contains no new matter.

Note that this invention called FIRESHIELD has received a U.S. Provisional Patent that was recently issued to the writer:

| | |
|---|---|
| Inventor: Henry August | also Henry August |
| Application number 61/200,125; and | 61/276,398 |
| Confirmation No. 2916; | 4544 |
| Filing date: Nov. 25, 2008; | Sep. 11, 2009 |
| Formalities letter dated: Jan. 5, 2009; | Oct. 23, 2009 |

### DECLARATION OF ORIGINALITY

The writer, Henry August, declares that he is the sole originator of the subject invention. To achieve cost savings, he has personally prepared and is pleased to submit this patent application to the USPTO so that a U.S. nonprovisional unitary patent award might be gained.

### BRIEF BACKGROUND OF THE INVENTION

### Description of the Problem

Recent wildfires in California, like the one that raged through north Orange County during November 2008, destroyed 113 homes in Yorba Linda spewing billions of embers into the air. Similarly, wildfire embers caused the loss of 500 mobile homes in Sylmar. Santa Ana winds drive these burning projectiles horizontally for hundreds of yards, pelting homes far from the flame front. In 2007, almost two hundred thousand acres burned in southern California alone. In these fires, over five hundred thousand people were displaced from their homes and over fifteen hundred buildings were burned. Due to these wildfires, many people were injured and some died.

### BRIEF SUMMARY OF THE INVENTION

Attic Air Ventilation will be maintained

An externally mounted, oversized, sheet-like Fireshield panel is to be retrofitted over an existing rooftop attic vent with ‘standoff’ distance from the home's outer wall so as to provide an open air gap (about ¼ inch) along the Fireshield's inner surface wall regions. A distribution of raised studs placed along the attic vent's outer perimeter will be used to assure this open air gap thereby providing an inner channel for airflow to enter the attic's air vent. In this manner, attic air ventilation is readily preserved. To alleviate wind noise, these raised studs will be rubber treated so as to provide dampening of wind induced vibration and noise to the mounted FIRESHIELD panel.

### Statement of Significance

The Fireshield approach is unique and proposed testing plans are designed to demonstrate its effectiveness as a barrier-like device capable of preventing wildfire embers from entering a structure's attic through its air vents while preserving the mold-resistant qualities as that of an open air vent. In this manner, inner-attic fire starts caused by ingested swarms of embers can largely be avoided and, thereby, many lives and homes could be saved. Too often firefighters standing on a rooftop with their spraying water hoses are defeated in their efforts to save structures because wind blown brush fire embers were driven through an attic's air vent wherein roofing materials within the attic became ignited and the entire home was destroyed (Reference 1; see FIG. 1).

The development of a low cost FIRESHIELD device that can be retrofitted to an attic (see FIGS. 2 and 3) could largely prevent devastating losses to lives and homes in the aftermath of ember driven wildfires. A low cost fire protection system of this kind could be successful in saving billions of dollars per year by providing these innovative devices to urban home communities that are subjected to and threatened by storming wildfires.

Current air vent designs for rooftop attics of homes and other building structures allow the influx of wind driven swarms of burning embers initiating from surrounding brush fires and this often leads to in-attic fires and the destruction of lives and homes. Even ¼-inch screen barriers placed on air vents have failed to prevent such embers from penetrating through and smaller grid mesh sizes are prone to clogging due to normal settling of outer debris and insect deposits.

This new innovation, called the FIRESHIELD concept, has been conceived for alleviating the cause of in-attic initiated fires. A retrofitable product of this kind has yet to be developed; however, a ‘non-burning’ prototype test has shown promising results (using confetti-like particles flowing against a small-scaled model of a barrier-like, shielding panel that acts as a preventive penetration device). Unlike the simulated air vent-like panel that allowed particle penetration through open slots, an added FIRESHIELD-like panel totally prevented particle penetration and these results were recorded by photos. Also, a recently proposed program has been submitted to the Building and Fire Research Laboratory (BFRL) of the National Institute of Standards and Technology (NIST) to perform shield-like demonstrations by preliminary testing techniques for showing that current home attic air ventilation designs can be improved upon by implementing FIRESHIELD modifications.

### FIRESHIELD—A Method of Fire Prevention for Homes Against Swarms of Wildfire Burning Embers

WILDFIRES CAN INITIATE DESTRUCTION OF HOMES
   Fire driven hot glowing embers emanating from surrounding burning brush can penetrate the air vents of home rooftops as well as community structures.
      Occurrences of this kind have caused many fires to ignite from within rooftop attics thereby endangering both lives and home properties (see FIG. 1).

| | Page |
|---|---|
| LIST OF CONTENTS | no. |
| STATEMENT OF NO NEW MATTER | 1 |
| DECLARATION OF ORIGINALITY | 2 |
| BRIEF BACKGROUND OF THE INVENTION | 2 |
| Description of the Problem | 2 |
| ABSTRACT | 3 |
| BRIEF SUMMARY OF THE INVENTION | 4 |
| Attic Air Ventilation will be Maintained | 4 |
| Statement of Significance | 4 |
| LIST OF CONTENTS | 7 |
| LIST OF CLAIMS | 9 |
| ‘FIRESHIELD’ DEVICE PERMITS ATTIC VENTILATION | 10 |
| Technical Proposal of a FIRESHIELD Device was submitted to | 10 |
| NIST | |
| BACKGROUND | 11 |
| ‘FIRESHIELD’ DEVICE STOPS THREATENING EMBERS | 11 |
| ‘FIRESHIELD’ DEVICE ACCOMMODATES ATTIC VENTING | 12 |
| FIRESHIELD PANEL CAN DISPLAY A ‘CANVAS OF ART’ | 13 |
| PRELIMINARY DEMONSTRATION OF EFFECTIVENESS | 13 |
| PRIOR ART | 14 |
| PROPOSED TEST PLANS FOR FUTURE DEMONSTRATIONS | 14 |
| OF ‘FIRESHIELD’TECHNIQUES WERE OFFERED | |
| ‘FOLLOW-ON’ WIND TUNNEL TESTING AT BRI | 16 |
| WAS PREPARED | |
| A TESTING SCHEDULE WAS PLANNED | 16 |
| Proprietary Material | 16 |
| REFERENCES | 17 |
| DESCRIPTION OF FIGURES | 18 |
| RESUME′ | 25 |
| Proof of Age - CA Driver's License | 26 |

| | | Page |
|---|---|---|
| LIST OF FIGURES | | no. |
| 1. | High Winds Threaten Starting of In-attic Home Fires | 21 |
| 2. | Modified Attic Air Vents | 21 |
| 3. | Considerations of Candidate ‘FIRESHIELD’ Materials | 22 |
| 4. | ‘FIRESHIELD’ Approach for Protection of Homes | 22 |
| 5. | Sketch of a Sample ‘FIRESHIELD Panel’ | 23 |
| 6. | TYPICAL INSTALLATION OF FIRESHIELD DEVICE - | 23 |
| | PANEL ATTACHMENT TO AN ATTIC'S AIR VENT | |
| 7. | FIRESHIELD PANEL PREVENTS ENTRY OF | 24 |
| | FIRE EMBERS | |

### ‘Fireshield’ Device Permits Attic Ventilation

An oversized, sheet-like Fireshield panel (such as aluminum sheet material) is to be retrofitted and externally mounted over an existing attic vent with ‘standoff’ distance from the home's outer wall so as to provide an open air gap (about ¼ inch) along the Fireshield's inner wall border regions. A distribution of a few raised rubber studs placed along the attic vent's outer perimeter would be used to maintain this open air gap thereby providing an inner channel for air to flow through and reach the attic's air vent. In this manner, outer air flow is allowed to readily enter as well as readily exhaust from the attic via its current air vent and added Fireshield device mounted with ‘standoff’ so as to provide an inner-channeling air gapped region.

Subsequently, the successful development of the FIRESHIELD device may prove to be a very valuable asset for saving many lives as well as protecting urban homes and other structures from destruction by fire.

Despite the urgent need, a low cost, readily retrofitable approach for the prevention of in-attic fires started by wildfire embers that are ingested through the air vent of the attic does not exist in the marketplace.

Technical Proposal of a FIRESHIELD Device was submitted to NIST A low cost, barrier-like Fireshield device that is retrofitable to standard air vents of existing home attics has been conceived by the writer and a one-year proposal effort to evaluate its effectiveness as a preventive measure against swarms of wildfire embers from entering the air vents of roof attics of typical homes and building structures was offered for gaining Fire Grant Program research support from the Building and Fire Research Laboratory (BFRL) of the National Institute of Standards and Technology (NIST). This agency has been actively pursuing wind tunnel studies particular to the nature of wildfire driven embers and their behavior for igniting in-attic fires (Reference 2). Unfortunately, this proposal for evaluation of the Fireshield device (see Reference 3) was not awarded.

Despite this setback, the successful development of the FIRESHIELD device can prove to be a very valuable asset for saving many lives as well as protecting urban homes from damage and destruction by fire.

### BACKGROUND

Recent wildfires in California, like the one that raged through north Orange County during November 2008, destroyed 113 homes in Yorba Linda spewing billions of embers into the air. Santa Ana winds drive these burning projectiles horizontally for hundreds of yards, pelting homes far from the flame front. Just one ember getting through an attic air vent could lead to the destruction of lives and homes (FIG. 1).

Current air vent designs allow the influx of wind driven swarms of burning embers initiating from surrounding brush fires and this often leads to in-attic fires and the destruction of homes (Reference 1). Even ¼-inch screen bathers placed on air vents have failed to prevent these embers from penetrating through and smaller mesh sizes are prone to clogging due to natural deposits of outside debris and settling insects seeking to build cell-like structured nests.

### ‘Fireshield’ Device Stops Threatening Embers

Modification of these air vents with the retrofitting of an oversized FIRESHIELD panel (see FIG. 2) mounted with a narrow ‘standoff’ gapped region acts as a barrier to the driven embers and also forms an air channel pathway that accommodates air ventilation to the attic. This unique design is called a FIRESHIELD device and covers the typical air vent with an external attachment of a low cost, oversized sheet-like panel mounted so as to provide a narrow ‘standoff’ from the rooftop air vent.

A lightweight panel of aluminum sheet stock is considered a candidate material for the ‘FIRESHIELD’ panel (FIG. 3). In addition to its durability, stiffness and high strength, aluminum provides a ‘heat sink’ quality that acts to defuse the threatening embers.

This arrangement presents a baffle-like pathway that cannot be negotiated by the ember particles. Consequently, these embers are stopped and thereby prevented from penetrating through the air vent and into the rooftop attic (FIG. 4).

### ‘Fireshield’ Device Accommodates Attic Venting

An oversized, sheet-like Fireshield panel is to be retrofitted over an existing attic vent with ‘standoff’ distance from the home's outer wall so as to provide an open air gap (about ¼ inch) along the Fireshield's inner wall border regions. A distribution of a few raised rubber studs placed along the attic vent's outer perimeter would be used to maintain this open air gap thereby providing an inner channel for air to flow through and reach the attic's air vent. In this manner, outer air flow is allowed to readily enter as well as readily exhaust from the attic via its air vent and Fireshield ‘standoff’ formed air gapped regions (see FIGS. 4 through 6).

A low cost retrofit approach for mounting of a ‘Fireshield panel to a Gable-like air vent of a home's rooftop attic is sketched below (see FIGS. 6 and 7).
Air Particles are gaseous media (light masses) and airflow can readily negotiate along narrow and tight turning pathways dictated by the FIRESHIELD panel; thereby air can enter and exit rooftop attic via air vents as depicted in FIG. 7.
Wind driven hot embers are solid debris particles (heavy masses) and cannot negotiate along narrow and tight turning pathways dictated by the FIRESHIELD panel; thereby embers cannot enter and exit rooftop attic via air vents as depicted in FIG. 7.

### Fireshield Panel can Display a ‘Canvas of Art’

In addition to providing fire protection to homes and other community structures, a FIRESHIELD panel over the planform of a home's attic air vent. In this manner, the mounted ember shielding panel provides added aesthetic value to the home. Selected art can be applied to the external surface of the FIRESHIELD panel by painting or decal-like appliqués.

### Preliminary Demonstration of Effectiveness

A ‘non-burning’ demonstration of the FIRESHIELD technique was performed and photographic results of its success were taken. These preliminary data show the FIRESHIELD technique to be highly effective as a venting barrier to air driven streaming particles. Lightweight styrene sheet materials were used to construct a see-thru chamber into which streams of confetti-like particles driven from a ‘hand-squirt’ plastic bottle were pneumatically injected and directed so as to readily penetrate a vent-like slotted wall. The addition of a planar FIRESHIELD-like device (oversized panel and with a narrow standoff air gapped region was positioned upstream of this slotted wall so as to represent the ‘shielded’ air vent of an attic). For the shielded case, complete prevention of entry by the ‘confetti’ particles was achieved.

### PRIOR ART

The Brandguard Vents (located in San Clemente, Calif.) produces a replacement product for the prevention of home fires that can initiate by the entry of urban wildfire embers through rooftop air vents. Their device consists of a multi-layered system of overlapping baffles made of folds of heavy steel sheet material. This more complex system is labor intensive in its design, construction and installation and requires the complete removal as well as the replacement of the existing rooftop air vents. As such, the Brandguard design and product requires skilled labor and is considered more costly compared to the retrofitable FIRESHIELD device that is readily made and installed as described herein.

Proposed Test Plans for Future Demonstrations of the ‘Fireshield’ Technique were Offered

A fire demonstration of this methodology for the prevention of home attic fires by either experimental or analytical means has yet to be performed. However, preliminary test plans have been conceived and planned for proposed efforts to BFRL at NIST for funding support offered under their Fire Grant and SBIR programs (Reference 3), however, government funding was not awarded.

Two such preliminary test demonstration programs of the Fireshield's effectiveness as a particle barrier were considered; namely,
1. Desktop Demonstration (non-burning; using injected confetti-like particles for aiding flow visualization).
2. Under the proposed effort to BRI, wind tunnel flow paths around target objects were to be observed (via non-burning, chemical derived smoke to be injected into the upstream tunnel airstream for aiding flow visualization @ Texas A&M low speed wind tunnel). Due to safety issues and concerns, USA wind tunnels such as at TAMU do not permit in-tunnel use of burning or flammable materials.

The rectangular test section of the OWN low speed wind tunnel at Texas A&M is 7 feet high, 10 feet wide and 12 feet long. Built into the tunnel floor is a 7 feet diameter turntable that can be used for the setting of a floor-mounted test model to selected sideslip angles, ψ, relative to the airstream. The writer has recent wind tunnel testing experience at this facility wherein a flow visualization technique using injected smoke as a flowpath tracer along an advanced configured air vehicle test model was observed and these data were recorded on video (Reference 4).

In addition, a cost estimate has been obtained from TAMU for the construction of a floor-mounted, box-like plexiglass walled wind tunnel test model (40 inches high by 40 inches wide by 40 inches length; with the box's floor centerline set along the streamwise centerline of the floor's turntable when set at zero sideslip angle) with simulated frontal facing open air vent slots; about 0.10 inch wide). Three Fireshield surfaces having a set of oversized border widths: 3, 4 and 5 inches and each with a given standoff air gap of 0.025 inches. These panels are to be constructed and fitted over the air vent region. The effectiveness of these shield-like surfaces to prevent smoke passage through the open gap slots are to be included for testing by TAMU and test results will be recorded by overhead and sidewall viewing video cameras. Further, flow visualization testing will be obtained with various sideslip settings, ψ, of the attic-like box structure; namely,
ψ=0, 30, 60, 90, 120 and 180 degrees
   and these results were to be observed and recorded for the various test configurations (with and without the attached FIRESHIELD panels).

### ‘Follow-on’ Wind Tunnel Testing at BRI was Planned

As part of this proposed effort to NIST, a third FIRESHIELD demonstration test program was to be coordinated and planned with BRI located in Japan in preparation for a ‘follow-on’ proposal effort; namely,
3. Wind tunnel flow paths testing (using burning embers @ Building Research Institute (BRI)) was planned to be performed as a future subcontract under NIST (note that controlled in-tunnel burning of embers are regularly undertaken at the BRI facility. Unfortunately, funding for this effort was not provided.

### A Testing Schedule was Prepared

A one-year FIRESHIELD test program was proposed to BFRL at NIST and a preliminary testing scheduling was prepared (Reference 3). In addition, cost estimates were made for the proposed program to NIST.

### Proprietary Material

This new innovation, called the FIRESHIELD method, has been conceived for alleviating the source of in-attic initiated fires started by penetrating embers that are wind driven debris particles from surrounding wildfires. This unique method has received a U.S. Provisional Patent that was recently issued to the writer. Consequently, these concepts and approaches for advancing these innovations and advanced techniques are considered Proprietary:

| | |
|---|---|
| Inventor: Henry August | Henry August |
| Application number 61/200,125; and | 61/276,398 |
| Confirmation No. 2916; | 4544 |
| Filing date: Nov. 25, 2008; | Sep. 11, 2009 |
| Formalities letter dated: Jan. 5, 2009; | Oct. 23, 2009 |

Henry August is the sole inventor of the ‘FIRESHIELD DEVICE FOR HOME PROTECTION AGAINST THREATENING WILDFIRES’.

### REFERENCES

1. ‘Even Fire-resistant Homes can Burn,’ written as a Los Angeles Times newspaper article, dated Nov. 18, 2008.
2. Manzello, S. L., Shields, J. R., Yang, J. C., Hayashi, Y. and Nii, D., ‘On the use of a Firebrand Generator to Investigate the Ignition of Structures in Wildland-Urban Interface (WUI) Fires,’ 2008.
3. August, H., ‘Technical Proposal for Evaluation of a Low Cost FIRESHIELD Device for home Protection Against Threatening Wildfires,’ submitted to the Building and Fire Research Laboratory (BFRL) of the National Institute of Standards and Technology (NIST), Apr. 4, 2009.
4. August, H. and Multhopp, D., AIAA-2008-0313, ‘Arch Wing and Conformal Forward Steering Devices,’ January 2008.

### DESCRIPTION OF FIGURES

FIG. 1—HIGH WINDS THREATEN STARTING OF IN-ATTIC HOME FIRES

Upon their entry through typical rooftop air vents, driven swarms of flying ember emanating from upwind wildfire regions can enter rooftop attics and initiate attic home fires from within.

FIG. 2—MODIFIED ATTIC AIR VENTS

External mounting of a ‘FIRESHIELD’ sheet-like panel over the planform area of a typical attic's air vent (oversized by an added border strip of about 2. to 4. inches and with a ‘standoff’ gap of about 0.25 inch) acts as a barrier to fire driven particles. This unique device prevents the fire embers from penetrating the attic via its air vent thereby saving the home/structure from damage or destruction by fire.

FIG. 3—CONSIDERATIONS OF CANDIDATE ‘FIRESHIELD’MATERIALS

Low cost, light weight approved ‘Fire resistant’ rooftop materials such as aluminum sheet, Kevlar, composites, ceramics and hybrids are candidate materials for ‘FIRESHIELD’ panels.

FIG. 4—‘FIRESHIELD’ APPROACH FOR PROTECTION OF HOMES

By acting as a shield-like barrier to wind driven fire embers, the FIRESHIELD panel reflects heavier solid particles from entry through a rooftop's attic air vent and thereby prevents home fires. The much lighter air particles readily negotiate the serpentine inner-pathways offered by the ‘standoff’ gap region of the outer FIRESHIELD panel relative to the air vent openings thereby attic ventilation is retained for relieving moisture build-up within the rooftop attic.

FIG. 5—SKETCH OF A SAMPLE ‘FIRESHIELD PANEL’

A planview sketch of an externally mounted ‘FIRESHIELD’ aluminum panel mounted over a typical rooftop attic air vent is depicted. Relative to the air vent's planform, the oversized dimensions of the FIRESHIELD panel includes a 2. inch added border as noted. Also shown are champhered corners on the FIRESHIELD which provide for increased safety in handling of the panel to the installer compared to the sharper-pointed squared corners offered by the rectangular shaped planform of the basic aluminum panel.

FIG. 6—TYPICAL INSTALLATION OF FIRESHIELD DEVICE—PANEL ATTACHMENT TO AN ATTIC'S AIR VENT

A typical attachment approach for mounting a FIRESHIELD panel to a rooftop attic's air vent using wooden screws that are driven into the existing wooden frame of the current air vent structure. A ‘standoff’ air gap of about 0.25 inch is provided to allow airflow ventilation thereby alleviating the buildup of excessive moisture that can cause decay of materials used within the attic. As shown, the use of rubber washers are included to provide energy damping of wind driven forced vibrations and noise generation initiating from the mounted FIRESHIELD panel.

FIG. 7—FIRESHIELD PANEL PREVENTS ENTRY OF FIRE EMBERS

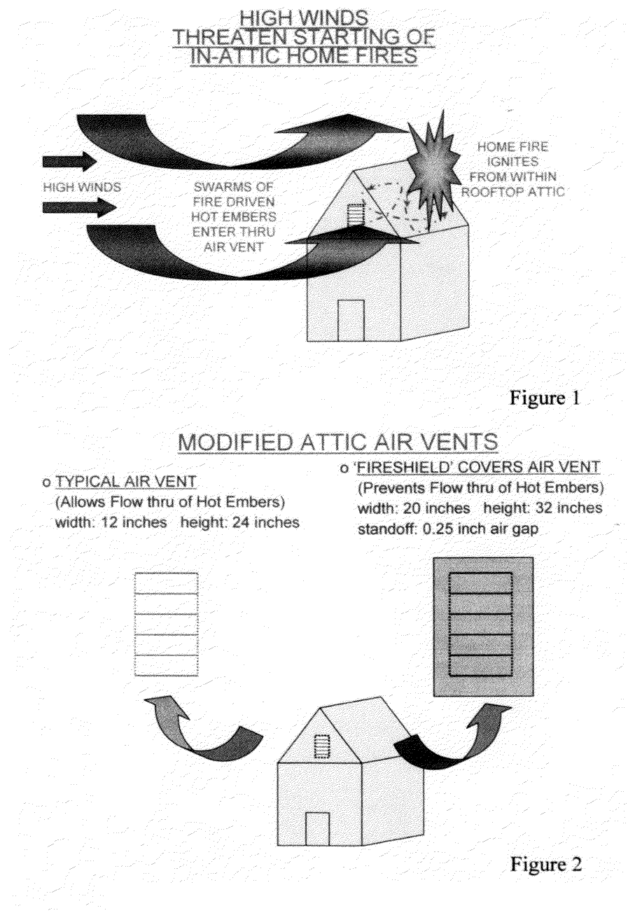

As a shield-like barrier to threatening wind driven fire embers, the FIRESHIELD panel is used to reflect the solid ember particles from entry into a rooftop's attic via its air vent. In this manner, the common start of in-attic home fires initiated by urban wildfire embers can be prevented.

The wind driven air particles are gaseous and much lighter in mass than are the ember particles. As such, the airflow can readily negotiate the serpentine-like inner-pathways offered by the ‘standoff’ gap region of the installed FIRESHIELD panel relative to the air vent openings. In this manner, needed attic ventilation for relieving moisture build-up within the rooftop attic is retained. Also shown is a ‘rapid’ labor saving attachment technique in which hook-ended bungee cords may be utilized.

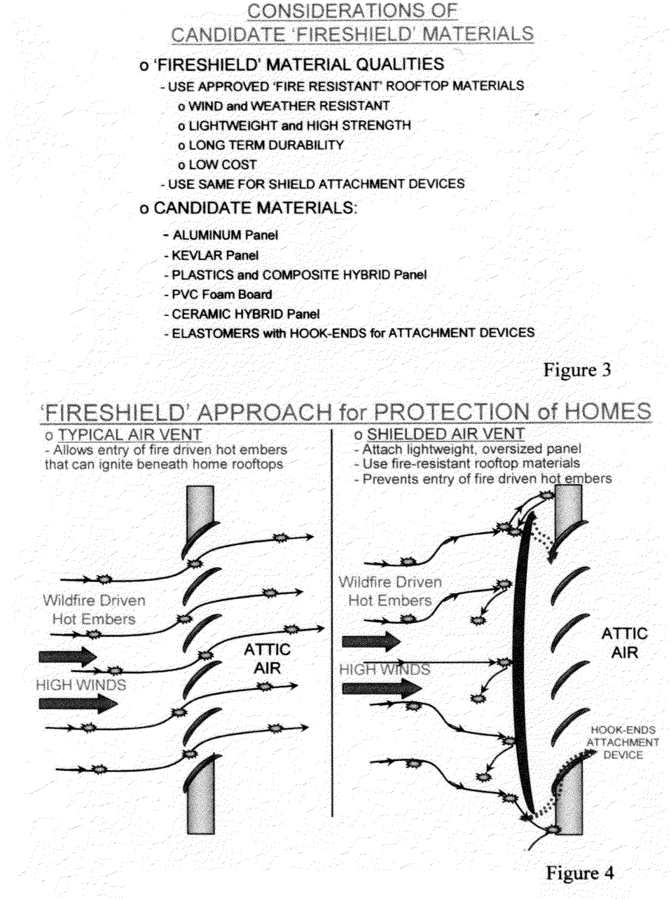

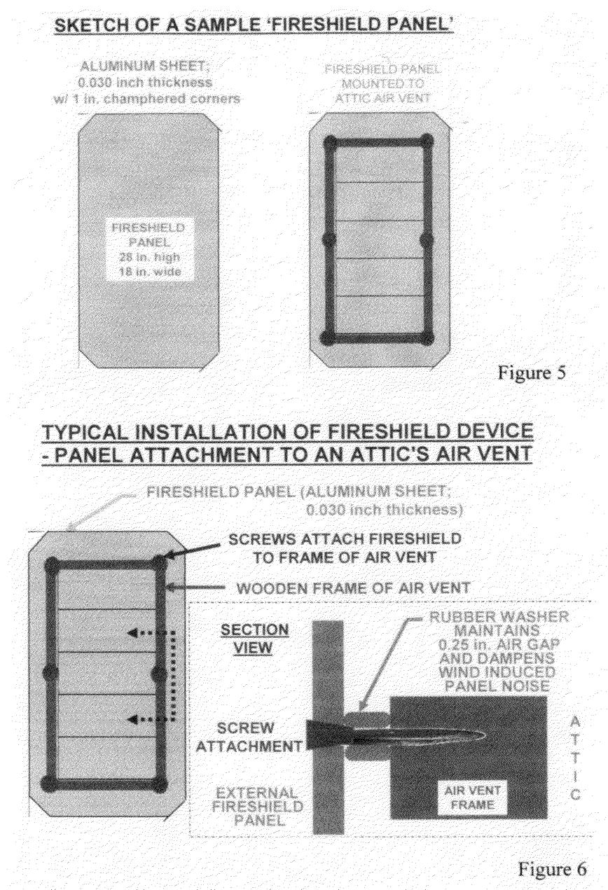

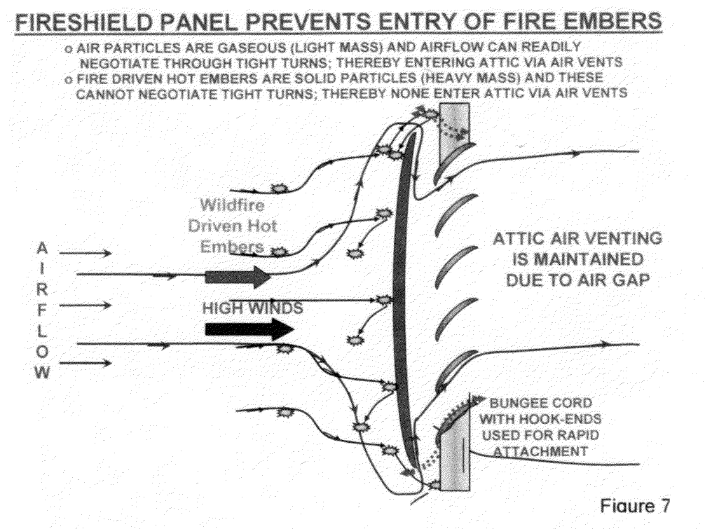

1. To prevent this threatening occurrence to homes, a low cost, unique ember shielding device has been conceived and designed (see FIGS. 2 and 3). This FIRESHIELD panel is outer-mounted to the air vent and oversized such that it covers the air vent's planform with an added border strip of about 2-4 inches and a small standoff to the air vent must be maintained (air gap of about 0.25 inch; FIG. 2). The FIRESHIELD acts to repel the flow of fire driven burning embers upon impact thereby preventing their entry into the rooftop attic of a home/structure via its air vent. The FIRESHIELD technique for preventing the entry of embers into rooftop attics is applicable to various planform shapes of typical attic air vents such as Gable end, Dorman, under eave vents, etc.
Flame resistant, planar-like shielding devices (made of lightweight, low cost materials such as aluminum or ‘fire resistant’ composite sheet stock) are to be used as external barriers for preventing fire embers from entering a rooftop through its air vents (see FIGS. 3 thru 7). The FIRESHIELD is low cost, retrofitable and can be readily installed. In this manner, the saving of lives and the protection of community properties from wildfires that threaten to ignite homes from within rooftops due to attic entry of wind driven burning embers are largely assured.
The FIRESHIELD panel can also be used to externally display a ‘Canvas of Selected Art’. In this manner, the aesthetic value of a community's homes can be enhanced.
